(19) United States
(12) Patent Application Publication
(10) Pub. No.: US 2025/0123228 A1
(43) Pub. Date: Apr. 17, 2025

(54) GAS MEASURING DEVICE AND GAS MEASURING PROCESS FOR MEASURING OF A HIGH TARGET GAS CONCENTRATION

(71) Applicant: Dräger Safety AG & Co. KGaA, Lübeck (DE)

(72) Inventors: Jürgen OSSWALD, Lübeck (DE); Angela LANGE, Lübeck (DE)

(21) Appl. No.: 18/910,154

(22) Filed: Oct. 9, 2024

(30) Foreign Application Priority Data
Oct. 12, 2023 (DE) 10 2023 127 831.2

(51) Int. Cl. G01N 25/30

(52) U.S. Cl. CPC G01N 25/30

(57) ABSTRACT

A gas measuring device (100) and a gas measuring process measure a concentration of a combustible target gas relatively reliably. An electrical voltage (U10, U11) is applied to both a detector (10) and a compensator (11). The applied electrical voltage heats an electrically conductive segment (20) of the detector (10) and an electrically conductive segment (38) of the compensator. The heated detector segment (20) oxidizes combustible target gas (CH₄), while a passivation coating on the compensator segment (38) largely prevents the compensator segment (38) from oxidizing combustible target gas (CH₄). The passivation coating includes iodine. The gas measuring device (100) determines the target gas depending on the temperature of the detector segment (20) and the temperature of the compensator segment (38) when operated in an oxidation measurement mode, and depending only on the temperature of the compensator segment (38) when operated in a heat conduction measurement mode.

### CROSS REFERENCE TO RELATED APPLICATIONS

This application claims the benefit of priority under 35 U.S.C. § 119 of German Application 10 2023 127 831.2, filed Oct. 12, 2023, the entire contents of which are incorporated herein by reference.

### TECHNICAL FIELD

The invention relates to a gas measuring device and a gas measuring process which are capable of measuring the concentration of a combustible target gas in a spatial area relatively reliably even if the target gas is present at a high concentration.

### BACKGROUND

If a combustible target gas escapes in a spatial area and this event is not detected, it can lead to an explosion or other danger to human beings. It is therefore important to detect the occurrence of a combustible target gas quickly.

Gas measuring devices comprising a detector and a compensator have become known. An electrically conductive segment of the detector is heated and oxidizes combustible target gas in a gas sample. The oxidation of the target gas releases thermal energy, which further heats the detector segment. The temperature of the detector segment therefore correlates with the target gas concentration to be measured. An indicator of the temperature of the detector segment is measured. The compensator makes it possible to computationally compensate for the influence of ambient conditions on the detector, in particular the respective influence of the ambient temperature, the ambient pressure, and the ambient humidity. Ideally, the compensator does not oxidize any target gas, but reacts to ambient conditions in the same way as the detector. Such gas measuring devices are also referred to as “heat tone sensors” or “catalytic sensors”. The invention also uses this principle.

The temperature of the detector segment only correlates reliably with the target gas concentration to be measured as long as the detector segment is still able to oxidize combustible target gas. If the target gas concentration is high, a situation may arise in which there is combustible target gas inside the gas detection device, but no more oxygen to oxidize this combustible target gas. If the determination of the target gas concentration is based on the temperature of the detector segment also in this situation, the gas detection device may provide incorrect results. In particular, there is a risk that a high concentration of a combustible target gas will not be detected.

### SUMMARY

It is an object of the invention to provide a gas measuring device and a gas measuring process which are able to determine the concentration of a combustible target gas in a spatial area relatively reliably even if the target gas is present in a relatively high concentration.

The problem is solved by a gas measuring device with features according to the invention and by a gas measuring process with features according to the invention. Advantageous embodiments of the gas measuring device according to the invention are, where appropriate, also advantageous embodiments of the gas measuring process according to the invention and vice versa.

The gas measuring device according to the invention and the gas measuring process according to the invention are configured to determine the concentration of a combustible target gas, wherein this target gas has occurred or can occur in a spatial area to be monitored. The target gas is, for example, methane (CH₄) or hydrogen (H₂). As a rule, the gas measuring device according to the invention and the gas measuring process according to the invention provide an estimated value for (an indicator of) the actual target gas concentration.

It is possible that several combustible target gases are simultaneously present in the spatial area. In this case, preferably the sum of the concentrations of these combustible target gases is measured. In the following, the term “target gas concentration” is used for short, even if several combustible target gases are present.

The gas measuring device comprises a detector and a compensator. The detector comprises an electrically conductive detector segment. The compensator comprises a compensator functional component with an electrically conductive compensator segment. The gas measuring device is configured to apply an electrical voltage to the detector and an electrical voltage to the compensator. The electrical voltage applied to the compensator can always be the same as the electrical voltage applied to the detector. It is also possible for the two applied voltages to differ from each other. The electrical voltage applied to the detector and/or the electrical voltage applied to the compensator can be constant or can vary over time.

At least temporarily, a gas sample flows from the spatial area to be monitored into the interior of the gas measuring device, for example because the gas measuring device sucks in the gas sample and/or the gas sample diffuses into the interior. At least part of the gas sample reaches the detector, and at least part of the gas sample reaches the compensator.

As long as an electrical voltage is applied to the detector, an electrical current flows through the detector segment. This current heats the detector segment. The heating of the detector segment causes combustible target gas inside the gas detection device to oxidize. The oxidation releases thermal energy. This thermal energy increases the temperature of the detector segment through which the current flows. This effect occurs when sufficient oxygen for oxidation is available. Otherwise this situation can occur that combustible target gas is not oxidated and that thermal energy is not released.

As long as an electrical voltage is applied to the compensator, an electrical current flows through the compensator segment. This current heats up the compensator segment. The compensator is configured in such a way that ideally, even when the compensator segment is heated, the compensator does not oxidize any combustible target gas inside the gas detection device. In general, this ideal task is only be achieved approximately. Described below is how this task is achieved according to the invention at least approximately.

The gas measuring device comprises an overall (total) detection variable sensor. This overall detection variable sensor is capable of measuring an overall detection variable. This overall detection variable depends both on the temperature of the detector segment and on the temperature of the compensator segment. In a first alternative, the greater the temperature of the detector segment is, the greater the overall detection variable is, and the greater the temperature of the compensator segment is, the smaller the overall detection variable is. Conversely, in a second alternative, the greater the temperature of the detector segment is, the smaller the overall detection variable is and the greater the temperature of the compensator segment is, the greater the overall detection variable is.

Remark: In the following the formulation is used that a sensor is configured to measure a physical quantity or variable. This has the following meaning: This sensor directly measures the physical quantity of variable or measures a further quantity or variable which correlates with the quantity or variable to be measured and is therefore an indicator for the quantity or variable to be measured.

As long as there is still a sufficient amount of oxygen inside the gas detection device, which the detector segment can use to oxidize combustible target gas, the overall detection value correlates with the target gas concentration to be measured. The gas measuring device can therefore be operated in an oxidation measurement mode. In the oxidation measurement mode, the gas measuring device is configured to determine the target gas concentration depending on the measured overall detection variable. For example, in the oxidation measurement mode, the gas measuring device applies a predetermined proportionality factor or another predetermined functional dependency to a measured value of the overall detection variable.

The gas measuring device comprises a compensator detection variable sensor. This compensator detection variable sensor is capable of measuring a compensator detection variable. The compensator detection variable depends on the temperature of the compensator segment, but preferably depends less than the overall detection variable sensor and ideally not at all on the temperature of the detector segment. In one embodiment, the greater the temperature of the compensator segment is, the greater the compensator detection variable is and, in another embodiment, the greater the temperature of the compensator segment is, the smaller the compensator detection variable is.

The gas measuring device according to the invention can be operated in the oxidation measurement mode and additionally in a heat conduction measurement mode. In the heat conduction measurement mode, the gas measuring device determines the target gas concentration depending on the measured compensator detection variable and preferably does not use the overall detection variable. It is possible that the measured compensator detection variable is also used to derive the overall detection variable in the oxidation measurement mode and/or to check the detector.

The operation in the heat conduction measurement mode exploits the fact that many combustible target gases, especially methane and hydrogen, have a higher thermal conductivity than ambient air. Therefore, the heated compensator segment is cooled down by a combustible target gas, the cooling-down is achieved compared to a state free of combustible target gas. In many cases, the greater the target gas concentration is, the lower is the temperature of the compensator segment provided that the electrical voltage applied to the compensator remains constant. Therefore, the temperature of the compensator segment and thus also the compensator detection variable correlate with the target gas concentration to be measured.

If the heated compensator segment actually does not oxidize any combustible target gas, the temperature of the compensator segment is in many cases a relatively reliable indicator for the target gas concentration to be measured or at least an indicator for the presence or absence of combustible target gas. If, on the other hand, the heated compensator segment oxidizes combustible target gas, two opposing effects occur:
The oxidation of the target gas releases thermal energy, and the released thermal energy increases the temperature of the compensator segment.
As the combustible target gas has a higher thermal conductivity than ambient air, the target gas cools down the compensator segment.

Even if the compensator segment is able to oxidize the target gas only to a relatively small extent, in many cases the effect of oxidation overlays the effect of increased thermal conductivity. In this case, the compensator detection variable is no longer a reliable indicator for the target gas concentration. The invention provides a way of relatively reliably preventing in many cases the heated compensator segment from being able to oxidize combustible target gas.

According to the invention, the compensator segment has a passivation coating. This passivation coating surrounds the compensator functional component, i.e. forms the outer surface of the compensator functional component. Therefore, the passivation coating comes into contact with a gas sample inside the gas measuring device. Ideally, the passivation coating covers the entire compensator functional component, i.e. there are no gaps in the passivation coating. The passivation coating separates the gas sample from the compensator functional component, ideally completely. In this way, the passivation coating prevents the compensator functional component from coming into physical or chemical contact with the gas sample and ideally completely prevents the heated compensator segment from oxidizing combustible target gas. On the other hand, there is preferably thermal contact between the gas sample and the compensator functional component and thus also thermal contact between the gas sample and the heated compensator segment, so that a change in the thermal conductivity of the gas sample has an effect on the compensator segment and the compensator detection variable sensor is able to measure the change in thermal conductivity.

The passivation coating comprises a chemical compound. This chemical compound comprises iodine, in particular an iodide or an iodate. The passivation coating may additionally comprise other components, in particular due to an impurity that can generally not completely be avoided. The proportion of the chemical compound with iodine, measured in percent by weight (% by weight), in the passivation coating is at least 50%, preferably at least 80%, particularly preferably at least 95%.

In internal tests, the inventors have found that a passivation coating with this chemical compound and with this proportion in percent by weight is particularly good at preventing the undesirable event of the heated compensator segment oxidizing combustible target gas to a relevant extent. This desirable preventive effect persists during a relatively long use of the gas detection device, even if this use lasts several days, weeks or even months. Other possible chemical compounds for the passivation coating, on the other hand, do not achieve this desired preventing effect as reliably over a longer period of time. This desired effect also occurs with hydrogen (H₂) as the combustible target gas.

The chemical compound of which at least 50% by weight of the passivation coating consists is particularly preferably an iodide or an iodate of an alkali metal or alkaline earth metal. The alkali metal or alkaline earth metal is preferably potassium. The chemical compound is particularly preferably potassium iodide (KI) or potassium iodate (KIO₃). In internal tests, these two chemical compounds have been found to be particularly suitable for preventing relevant oxidation of combustible target gas over a long period of use. In internal tests, it was found that this desired effect is also achieved for hydrogen as the combustible target gas. It is also possible that the chemical compound is a mixture of potassium iodide (KI) and potassium iodate (KIO₃).

According to the invention, both the detector segment and the compensator segment are heated when an electric current flows through these two segments. Preferably, the detector segment is heated to a high temperature. In order to oxidize reliably all combustible target gases that may occur, this temperature is preferably between 450 and 550 degrees C. If only hydrogen (H₂) can occur as the combustible target gas and is to be reliably oxidized, it is in many cases sufficient to heat the detector segment to a temperature between 150 and 250 degrees C. Preferably, the compensator segment is heated in such a way that the temperature of the heated compensator segment deviates from the temperature of the detector segment by no more than 100 degrees C., preferably by no more than 50 degrees C.

A key reason for using a compensator in addition to the detector and heating the two segments to approximately the same temperature is as follows: The temperature of the detector segment is influenced not only by the electrical voltage applied to the detector and by the thermal energy generated during oxidation, but also by ambient conditions, in particular the ambient temperature, ambient humidity, and ambient pressure. As a rule, it is too complex to provide a sufficiently reliable sensor for each of these three environmental conditions and to process a signal from this sensor in order to determine the target gas concentration. The compensator is configured to compensate to a certain extent for the influence of the ambient conditions on the temperature of the detector segment, especially if the temperatures of the detector segment and the compensator segment differ by less than 100 degrees C. from each other. It is possible that the gas measuring device has a sensor for an ambient temperature, for example a temperature sensor, or is configured to receive and process a signal from a spatially distant sensor for an ambient condition.

The compensator also allows the gas measuring device to be operated in the heat conduction measurement mode.

Preferably, the passivation coating has a thickness of between 5 μm and 50 μm.

Preferably, both the detector segment and the compensator segment have a respective ceramic coating. The ceramic coating of the compensator is part of the compensator functional component. Preferably, the respective ceramic coating surrounds the detector segment or the compensator segment. The ceramic coating provides electrical insulation and has a relatively high thermal conductivity. Particularly preferably, a catalytically active material is embedded in the ceramic coating of the detector segment. This material comes into contact with a gas sample inside the gas measuring device and thus with combustible target gas. In particular thanks to the catalytically active material, the detector segment is able to oxidize combustible target gas even when the detector segment is heated to no more than 550 degrees C.

However, no catalytically active material is embedded in the ceramic coating of the compensator segment. The passivation coating separates the compensator functional component and thus the compensator segment and the ceramic coating of the compensator segment from the environment of the compensator and thus from combustible target gases in the gas sample. Therefore, the compensator functional component cannot come into physical or chemical contact with the environment, while thermal contact is still possible.

According to the invention, the gas measuring device can be operated either in the oxidation measurement mode or in the heat conduction measurement mode. Preferably, the gas measuring device is configured as follows: The gas measuring device measures the target gas concentration in the oxidation measurement mode for as long as sufficient oxygen is present such that the heated detector segment is able to oxidize the combustible target gas. Only if this condition is not met with sufficient certainty, the gas measuring device automatically switches into the heat conduction measurement mode. One reason is the following: As a rule, the measured values obtained by the gas detection device when operating in the oxidation measurement mode are more reliable and/or more accurate than the measured values when operating in the heat conduction measurement mode, but only as long as there is still sufficient oxygen inside the gas detection device. In other words, the gas measuring device is operated in the oxidation measurement mode for as long as possible and is operated only in the heat conduction measurement mode when operation in the oxidation measurement mode no longer leads to reliable measured values.

According to this preferred embodiment, an oxidation criterion is given in a form that can be evaluated by a computer (in a computer-evaluable form). This oxidation criterion is given in such a way that it is fulfilled as long as sufficient oxygen is still present inside the gas measuring device so that the heated detector segment is able to oxidize a combustible target gas inside and therefore the overall detection variable is a suitable indicator for reliably determining the target gas concentration.

In a preferred implementation, the oxidation criterion is fulfilled at least if the following condition is met: The target gas concentration, which the gas measuring device has determined during operation in the oxidation measurement mode, is below a predetermined first upper concentration threshold. This first upper concentration threshold is predetermined in such a way that there is always sufficient oxygen present at least when the target gas concentration is below this upper concentration threshold.

According to this embodiment, the gas measuring device automatically switches to the heat conduction measurement mode when the target gas concentration, which is determined as a function of the overall detection variable, is above the first upper concentration threshold.

After being switched on, the gas measuring device is preferably first operated in the oxidation measurement mode. The gas measuring device remains in the oxidation measurement mode and determines the target gas concentration depending on the overall detection variable as long as sufficient oxygen is still present. As soon as the gas measuring device automatically detects that the oxidation criterion is no longer fulfilled, it automatically switches to the heat conduction measurement mode and measures the target gas concentration depending on the compensator detection variable.

Preferably, the first upper concentration threshold is determined empirically in advance, in particular as follows: If the target gas concentration has reached or exceeded the first upper concentration threshold, the detector segment is no longer able to oxidize all further target gas because oxygen in sufficient amount is no longer available. In this situation, the overall detection value is no longer a reliable indicator for the target gas concentration. Preferably, the gas measuring device switches back to the oxidation measurement mode when the target gas concentration determined using the compensator detection variable has fallen below this first upper concentration threshold or another upper concentration threshold.

In one embodiment, when operated in the oxidation measurement mode, the gas measuring device is configured to determine the target gas concentration not only depending on the overall detection variable, but also depending on the compensator detection variable. As a rule, the two estimated values for the actual target gas concentration obtained by these different ways differ from each other. In many cases, a comparison of these two estimated values makes it possible to check whether the detector is still working properly or is severely poisoned. “Poisoning” of a detector is understood to mean the process that harmful substances are deposited on a surface of the heated detector segment and the detector segment is therefore no longer able to oxidize a combustible target gas to a sufficient extent. In one embodiment, the gas measuring device is able to check itself automatically for poisoning.

According to an embodiment described above the gas measuring device automatically switches from the oxidation measurement mode to the heat conduction measurement mode when a predetermined oxidation criterion is no longer fulfilled. In one implementation, the oxidation criterion is not fulfilled if the following condition has occurred: The target gas concentration, which is determined on the basis of the overall detection variable, is above a predetermined first concentration threshold. In a further development of this implementation, a second upper concentration threshold is given. The second upper concentration threshold is greater than the first upper concentration threshold. The further development of this implementation uses the embodiment just described in which the gas measuring device being operated in the oxidation measurement mode determines the target gas concentration additionally depending on the compensator detection variable. The oxidation criterion is also no longer fulfilled, and the gas measuring device automatically switches to the heat conduction measurement mode if the following condition is fulfilled: The target gas concentration, which is determined on the basis of the compensator detection variable, is above the given second upper concentration threshold. Preferably, the gas measuring device switches to the heat conduction measurement mode in any case if this condition is met, regardless of which target gas concentration is determined depending on the overall detection variable.

This embodiment is a possible remedy in particular for the following situation: The target gas concentration in the area to be monitored fluctuates greatly or can at least fluctuate greatly, for example because a user carries the gas detection device into areas with different loads or because a combustible target gas can suddenly escape (strong increase) or because a leak from which combustible target gas escapes is sealed (closed-strong decrease). The target gas concentration can also increase significantly if a lot of target gas is present in an enclosed container and a probe of the gas measuring device is inserted from outside into the container. The step in which the gas detection device determines the target gas concentration based on the overall detection variable inevitably requires a certain amount of processing time. Therefore, in some situations, the gas detection device cannot detect a sudden high target gas concentration quickly enough when operating in the oxidation measurement mode. The further development of the implementation just described reduces the risk that this potentially dangerous event is not detected and therefore no alarm is issued.

In one embodiment the gas measuring device comprises a detector chamber and an oxygen sensor. The detector is arranged in the interior of the detector chamber. The detector chamber with the detector is arranged in the interior of the gas measuring device. At least the part of a gas sample from a spatial area to be monitored flows into the detector chamber and thereby in an environment of the detector. The oxygen sensor is arranged to measure the content of oxygen in the detector chamber. For checking whether the oxidation criterion is fulfilled, the gas measuring device is configured to use the measured oxygen content, i.e. at least one value measured by the oxygen sensor. Preferably the oxidation criterion is fulfilled if the oxygen content in the detector chamber is above a given lower threshold over a sufficiently long time span. Otherwise the oxidation criterion is not fulfilled.

According to the invention, the gas measuring device can be operated in the heat conduction measurement mode. In the heat conduction measurement mode, the gas measuring device determines the target gas concentration depending on the measured compensator detection variable. In one embodiment, no electrical voltage is applied to the detector segment permanently or at least temporarily when the gas measuring device is operated in the heat conduction measurement mode. In particular compared with an embodiment in which also in the oxidation measurement mode and electrical voltage is applied to the detector segment, this embodiment has the following advantages:
Generally, the gas sample inside the gas detection device and surrounding the detector has a high concentration of combustible target gas when the gas detection device is operated in the heat conduction measurement mode. If the detector segment were to oxidize combustible target gas even in this situation, the oxidation would release a particularly large amount of thermal energy and the detector segment could be heated up very strongly. This heating-up can lead to undesirable deposits on the detector segment (“coking”, “carbonizing”) and put the detector out of operation.
Furthermore, because there is usually not enough oxygen inside the gas detection device to oxidize all combustible target gas when operating in the heat conduction measurement mode, the strong heating can cause the detector to react chemically with the heated and only incompletely oxidized target gas in an undesirable way. For example, the target gas could extract oxygen from a ceramic coating of the detector. The chemical reaction could damage the detector.
The process of the electrical voltage applied to the detector segment heating the detector segment inevitably consumes electrical energy. As a rule, the gas detection device is not connected to a stationary power supply network, but has its own power supply unit. In particular in this case, it is important to consume relatively little electrical energy.

In one application of the invention, the gas measuring device is used to determine the concentration of hydrogen as the combustible target gas or a combustible target gas. Hydrogen is expected to become increasingly important, in particular as a low-emission energy carrier for drives or for generating electrical energy or as a starting material (source material) in the chemical industry.

In one embodiment, the gas measuring device according to the invention has an output unit. The gas measuring device causes an alarm to be output on this output unit in at least one form that can be perceived by a human being as soon as the gas measuring device has determined a target gas concentration above a predetermined threshold value. In addition or as an alternative, the gas measuring device causes the determined target gas concentration itself to be output. In particular, the output unit can emit the alarm visually, acoustically and/or haptically (through vibrations). Such a gas measuring device can be carried by a human being while this human being is in an area where combustible target gas may be present. It is also possible that the gas detection device is located in this area while at least one human being is carrying out work there.

In another embodiment, the gas measuring device according to the invention has a communication unit. Thanks to the communication unit the gas measuring device does not necessarily comprise an own output unit, on which output unit a measured target gas concentration is output. With the aid of this communication unit, the gas measuring device is able to transmit a message with a determined target gas concentration to a spatially remote receiver, and a display unit of the receiver is able to output the message in at least one form that can be perceived by a human being. Such a gas measuring device can be set up to be stationary (fixed) in or near an area to be monitored. Preferably, several such gas measuring devices are set up in or near this area.

One possible application of this other embodiment is as follows: The gas measuring device- or at least one transducer of the gas measuring device—is arranged in a completely or at least largely enclosed space, for example in a boiler or in a pipeline or in a container or in a room with a combustion system. Initially, the enclosed space is blocked against access. The display unit of the receiver is arranged outside this enclosed space and outputs a determined value for the target gas concentration visually and/or acoustically. A user or a control unit releases access to the enclosed space only if the determined target gas concentration is below a predetermined concentration threshold and therefore no danger for a human being is caused by combustible target gas. For example, work may only be carried out in the enclosed space that could lead to flying sparks if the target gas concentration is low enough.

In a variation, the gas measuring device is arranged completely outside the enclosed space. A hose or other fluid guide unit connects the gas measuring device to the enclosed space. A pump or other fluid delivery unit of the gas measuring device sucks in a gas sample from the enclosed space through the fluid guide unit. Alternatively, the gas sample diffuses through the fluid guide unit to the gas measuring device.

The invention is described below with reference to embodiments. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the Drawings:

FIG. 1 is a schematic view showing a first configuration of the gas measuring device, with the detector and the compensator arranged in a Wheatstone measuring bridge;

FIG. 2 is a schematic partially sectional perspective view showing a detector configured as a pellistor;

FIG. 3 is a schematic partially sectional perspective view showing a detector configured as a flat component;

FIG. 4 is a schematic view of a second configuration of the gas measuring device;

FIG. 5 is a graph showing the applied detection variables as a function of the target gas concentration;

FIG. 6 is a graph showing a result of a test with eight different possible passivation coatings; and

FIG. 7 is a graph showing a result of a long-term test with three different possible passivation coatings.

### DESCRIPTION OF PREFERRED EMBODIMENTS

Referring to the drawings, the gas measuring device according to the invention and the gas measuring process according to the invention are configured for monitoring a spatial area for the presence of at least one combustible target gas and/or for at least approximately determining the concentration of a combustible target gas in this area. In the embodiment, the target gas is hydrogen (H₂). The gas measuring device uses aspects of a technique known from the state of the art to examine a gas sample from the spatial area for the presence and/or concentration of hydrogen.

A detector is located inside a housing of the gas measuring device. Through an opening in the housing, a gas mixture diffuses from the area to be monitored into the interior of the housing or is conveyed into the interior, e.g. sucked in by a pump. In the embodiment, the interior of the housing is permanently in a fluid connection with the area to be monitored during use, so that a gas sample continuously flows into the interior of the housing.

The detector comprises an electrically conductive wire with a heating segment, whereby the heating segment is hereinafter referred to as the detector segment. The detector segment is, for example, a coil that forms a segment of the wire. The electrically conductive material is, for example, platinum or rhodium or tungsten (wolfram) or an alloy using at least one of these metals. An electrical voltage U is applied at least temporarily to this wire so that an electric current flows through the wire. The flowing current heats the detector segment, and the heated detector segment emits thermal energy. The emitted thermal energy causes at least one combustible target gas, in general every combustible target gas, inside the housing to be oxidized—of course only if the area and thus the interior contain at least one combustible target gas and if sufficient oxygen is available for oxidation.

In one application, methane (CH₄) is the combustible target gas or a combustible target gas to be detected. The addition of thermal energy causes methane to react with oxygen, producing water and carbon dioxide. CH₄ and 2 O₂ thus become 2 H₂O and CO₂. As is well known, hydrogen reacts with oxygen to form water (H₂O).

Due to the oxidation of the target gas, thermal energy is released inside the housing. This thermal energy acts on the detector and increases the temperature of the detector segment through which the current flows. This temperature increase correlates with the thermal energy released and thus with the concentration of the target gas inside the housing. A gas measuring device with such a detector is sometimes referred to as a “heat tone sensor”.

The change in temperature amends a property of the detector, for example the electrical resistance R of the detector segment through which the current flows, whereby the amended property correlates with the temperature of the detector segment. For many electrically conductive materials, the greater the temperature of the conductive material is, the higher is the electrical resistance R. The gas measuring device measures at least one measurable variable which is influenced by the property and thus the temperature of the detector segment and which is referred to below as the “detection variable”. The detection variable is, for example, directly the temperature or a variable that correlates with the electrical resistance R of the detector segment, for example the electrical voltage U applied to the detector or the current I or the electrical power P absorbed by the detector segment.

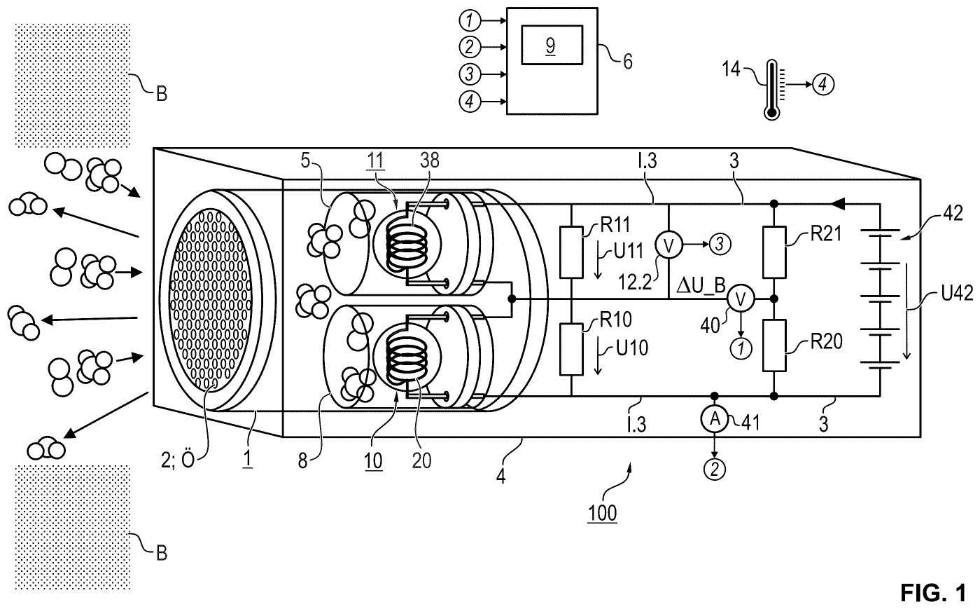

FIG. 1 shows in an example manner a gas measuring device 100 according to a first embodiment of the invention. In the embodiment, a detector 10 is arranged in a detector chamber 8 and a compensator 11 is arranged in a compensator chamber 5. The detector chamber 8 with the detector 10 and the compensator chamber 5 with the compensator 11 are located in a stable housing 1. Thanks to an opening Ö, the stable housing 1 is in a fluid connection with the area to be monitored, so that a gas sample can pass from the area to be monitored into the interior of the housing 1 and also into the interior of the detector chamber 8. A flame protection 2, for example a metallic grid, in the opening Ö reduces the risk of flames from the inside of the stable housing 1 spreading outwards. The stable housing 1 is surrounded by an outer housing 4, shown schematically, which is preferably easy to grip and hold.

The electrical voltage U applied to the detector 10 causes an electrical current to flow. The flowing current heats the detector segment 20 to a working temperature. If the heated detector segment 20 is to be capable of oxidizing all combustible target gases under consideration, this temperature is often between 450 degrees C. and 550 degrees C. In the case of hydrogen as the combustible target gas, a temperature between 150 degrees C. and 250 degrees C. is often sufficient. However, this working temperature alone is usually not sufficient to oxidize a combustible target gas in the inner housing 1. A higher working temperature is often undesirable because it could lead to burning or even exploding of the combustible target gas, which is often undesirable, and also consumes more electrical energy.

In order to be able to oxidize a combustible target gas despite a working temperature below 550° C., the detector 10 comprises a catalytic material which oxidizes the target gas in conjunction with the heated detector segment 20. A gas measuring device with such a detector 10 is therefore also referred to as a “catalytic sensor”.

In a frequently used implementation, the detector segment 20 is surrounded by electrical insulation, for example by a ceramic coating. This electrical insulation electrically insulates the detector segment 20 and in particular prevents an undesired short circuit. The electrical insulation is thermally conductive so that the detector segment 20 can release thermal energy into the environment of the detector 10 and, conversely, thermal energy from the environment can further heat up the detector segment 20. A coating of a catalytic material is applied to this electrical insulation. Alternatively, a catalytic material is embedded in the electrical insulation. This catalytic coating comes into contact with the gas mixture in the inner housing 1 and thus also with a combustible target gas. A detector 10 constructed in this way is often referred to as a “pellistor”.

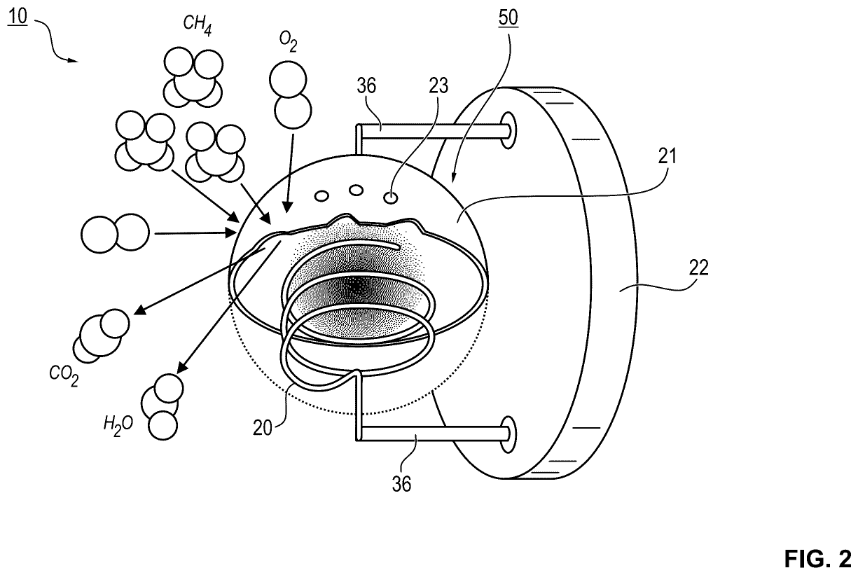

FIG. 2 shows an example of a detector 10 configured as a pellistor and a schematic diagram of the conversion of methane (CH₄) into CO₂ and H₂O. The detector 10 comprises
a spirally wound and electrically conductive wire 20, which acts as the detector segment and is made of platinum, for example,
a ceramic coating 21, which surrounds the detector segment 20 and has the shape of a solid sphere in the example shown,
a catalytic coating on the outer surface of the ceramic coating 21, which is indicated by circles 23 in FIG. 2,
a mounting plate 22, and
electrical connections and mechanical supports 36 for the wire 20.

The detector segment 20, the ceramic coating 21, the mounting plate 22 and the connections and supports 36 belong to a functional component 50 of the detector 10. The catalytic coating 23 surrounds the detector functional component 50 or is embedded in the detector functional component 50.

Platinum or palladium, for example, is used as the catalytic material. Alternatively, or in addition to the catalytic coating, catalytic material 23 can also be embedded in the ceramic coating 21.

In a preferred embodiment, the solid sphere of the detector 10 has a porous surface with a catalytic coating 23. In one embodiment, this porous surface is produced as follows: The detector functional component 50, i.e. the detector 10 with the porous surface but without the catalytic coating, is provided. The catalytic coating 23 is applied to the porous surface, for example in an immersion bath, and some of the catalytic material penetrates into the interior of the detector 10. It is also possible that a ceramic material and a catalytically active substance are mixed together and applied jointly to the detector segment 20, for example in an immersion bath.

Thanks to this porous surface, the detector 10 has a greater surface area compared to a detector with a smooth surface. Thanks to this greater surface area, the detector segment 20 is able to oxidize combustible target gas with a higher reliability, in particular because a greater amount of target gas comes into contact with the catalytic material. Thanks to the porous surface A gas can reach deeper layers of the detector 10.

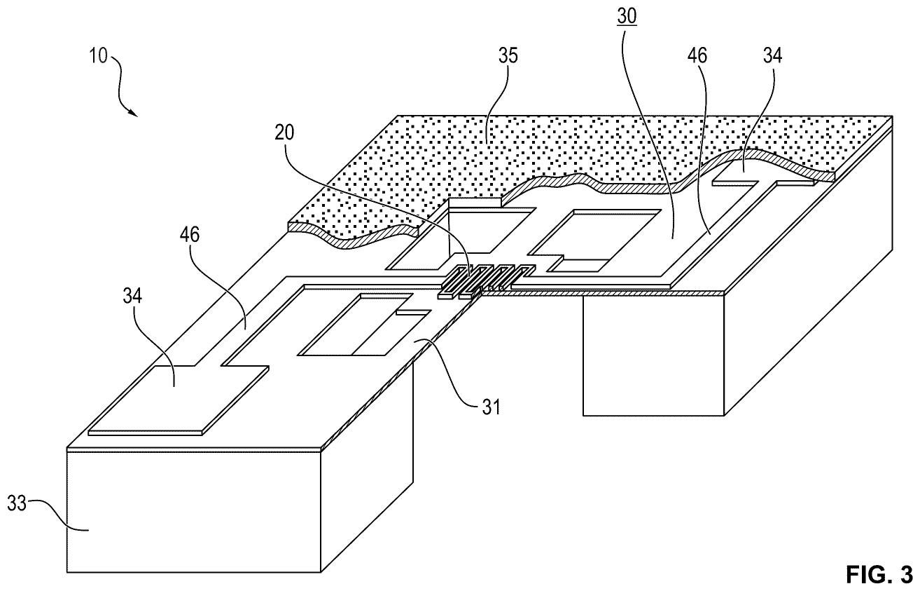

FIG. 3 shows a different configuration. According to this different configuration the detector 10 is configured as a flat component. The detector segment 20 is part of an electrically conductive conductor track (trace) 30, which also has an electrical connection 46 and electrical contact points 34. The conductor track 30 is attached to a carrier plate 31. A wafer substrate 33 carries the carrier plate 31. A protective layer 35 is applied to the conductor track 30 with the detector segment 20. In one embodiment, this protective layer 35 is catalytically active. In another embodiment, the protective layer 35 covers a catalytically active layer on the detector segment 20.

In one embodiment, the manufacture of the detector 10 comprises the following steps:
The wire for the detector segment 20 of the detector 10 is provided.
For applying the ceramic coating to the wire, a liquid (coating suspension) is applied.
A heating current is applied to the detector segment 20. By this the liquid dries and is calcined.

The liquid comprises the following three components:
a material that becomes catalytically active after drying, for example palladium nitrate [Pd(NO₃)₂] or hexachloroplatinic acid (H₂PtCl₆),
a carrier material, for example an oxide of the elements aluminum, silicon, cerium and/or zirconium, and
a solvent, for example water.

However, the temperature of the detector 10 and thus also the detection variable or a detection variable is not only influenced by the thermal energy released, but also by ambient conditions in the area to be monitored, in particular the ambient temperature, as well as humidity, ambient pressure and the concentration of non-combustible gases, e.g. CO₂, in the air. These ambient conditions can also change the conditions inside the inner housing 1. These ambient conditions can also influence the detector temperature and thus a detection variable, for example because the thermal conductivity in the vicinity of the detector 10 is changed. It is desirable that the gas detection device 100 is able to reliably detect a combustible target gas despite varying ambient conditions on the one hand and on the other hand only generates relatively few false alarms, i.e. only relatively rarely decides that a target gas is present, although in reality no target gas is present above a detection threshold. This obvious false alarm is an erroneous result.

In the embodiment, the gas measuring device 100 comprises an optional temperature sensor 14 which measures an indicator for the ambient temperature in an environment of the gas measuring device 100. Preferably, the temperature sensor 14 measures an indicator for the difference between the ambient temperature and a predetermined reference temperature.

The gas measuring device 100 comprises neither a sensor for the ambient pressure nor a sensor for the ambient humidity. The gas measuring device of the embodiment is also not necessarily configured for processing a signal from a sensor for the ambient pressure or a sensor for the ambient humidity. Rather, the gas measuring device 100 compensates constructively and/or computationally to a certain extent for the influence of those ambient conditions on the detection variable which ambient conditions are not directly measured, wherein the detection variable depends on the temperature of the detector segment 20. For this purpose, the gas measuring device 100 comprises a compensator 11 in addition to the detector 10, see FIG. 1. The compensator 11 also comprises a wire with a compensator segment. An electrical voltage U is also applied to the compensator 11 so that an electrical current flows and the segment of the compensator 11 is also heated. The compensator 11 is also exposed to the varying ambient conditions.

In a preferred embodiment, the compensator 11 also comprises a spirally wound and electrically conductive wire, which acts as the compensator segment and is designated by the reference sign 38. In addition, the compensator 11 also comprises a ceramic coating, a mounting plate, electrical connections and mechanical supports. In contrast to the detector 10, however, the ceramic coating of the compensator 11 is not provided with a catalytic coating. The compensator segment 38, the ceramic coating, the mounting plate, the connections and the supports belong together to a compensator functional component 51, which can in particular have the shape of a sphere or a plate, i.e. can have the shape of the detector 10 of FIG. 2 or that of FIG. 3.

FIG. 1 shows the compensator 11 in the compensator chamber 5. It can be seen that the detector 10 comprises the detector segment 20 and the compensator 11 comprises a compensator segment 38. In the example in FIG. 1, the compensator 11 is also configured as a spherical or ellipse-shaped pellistor, but unlike the detector 10 in FIG. 2, it does not have a catalytically active coating 23. The compensator 11 can also be configured as a flat component, as shown in FIG. 3.

FIG. 1 shows the following additional components of the gas measuring device 100:
an own voltage source 42, for example a set of rechargeable batteries,
an electrical line 3, which connects the voltage source 42 with the detector 10 and with the compensator 11,
a voltage sensor 40,
a voltage sensor 12.2,
a current (amperage) sensor 41,
two electrical resistor elements R10 and R11,
two electrical resistor elements R20 and R21, and
a signal-processing control unit 6.

Optionally, a thermal barrier, not shown, inside the gas measuring device 100 thermally separates the detector 10 from the compensator 11. The invention can also be implemented without such a thermal barrier.

The gas measuring device 100 shown in FIG. 1 is constructed as a Wheatstone measuring bridge. The voltage sensor 40 measures the bridge voltage ΔU_B in the Wheatstone measuring bridge. In the configuration shown in FIG. 1, this bridge voltage ΔU_B acts as the or an overall detection variable. In the first embodiment according to FIG. 1, the overall detection variable depends on the voltage U10 applied to the detector 10 and on the voltage U11 applied to the compensator 11 as follows: The greater the detector voltage U10 is, the greater is the overall detection variable, and the greater the compensator voltage U11 is, the smaller is the overall detection variable. The voltage sensor 12.2 measures the electrical voltage U11 applied to the compensator 11. The current sensor 41 measures the current (amperage) I.3 flowing through line 3.

The electrical resistor elements R10 and R20 are connected in parallel to the detector 10, the electrical resistor elements R11 and R21 are connected in parallel to the compensator 11. FIG. 1 shows
the voltage U42 of the voltage source 42,
the electrical voltage U10 applied to the detector 10 and
the electrical voltage U11 applied to the compensator 11.

The measured values from the sensors 40, 41, 12.2, 14 are transmitted to the control unit 6 and processed by the control unit 6. A signal-processing evaluation unit 9 derives an estimated value for the target gas concentration, in this case: the concentration of hydrogen, in the gas sample. In the embodiment, the evaluation unit 9 is a component of the control unit 6.

In the example shown in FIG. 1, the components form a Wheatstone measuring bridge. The detector 10 and the compensator 11 are connected in series. The electrical resistance of the voltage sensor 40 is high compared to the electrical resistances of the components 10, 11, R10, R11, R20, R21. In one embodiment, the voltage sensor 40 directly measures the so-called bridge voltage ΔU_B=(U10−U11)/2. The current I.3 is kept constant by closed-loop control, so that the voltage U is proportional to the electrical resistance R and thus correlates with the temperature of the detector segment 20. The actual current I.3 measured by the current sensor 41 is used for this control.

In one implementation, a pulsed voltage is applied in order to save electrical energy. The control gain (control objective) of keeping the current I.3 constant refers to the current during an electrical pulse. In another implementation, electrical voltage is permanently applied to the detector 10 and to the compensator 11.

A corrected bridge voltage ΔU_Bₖₒᵣᵣ=ΔU_B−ΔU_B₀ correlates with the target gas concentration sought. Here, ΔU_B₀ is the zero point, i.e. the bridge voltage ΔU_B that occurs when no combustible target gas is present in the area to be monitored and thus inside the gas detection device 100. This zero point ΔU_B₀ is preferably determined empirically in advance. The correction with the zero point ΔU_B₀ compensates for possible design-related differences between the detector 10 and the compensator 11. It is possible to determine the zero point ΔU_B₀ at least once again during the service life of the gas detection device 100.

In the configuration shown in FIG. 1, the corrected bridge voltage ΔU_Bₖₒᵣᵣ=ΔU_B−ΔU_B₀ acts as the overall detection variable.

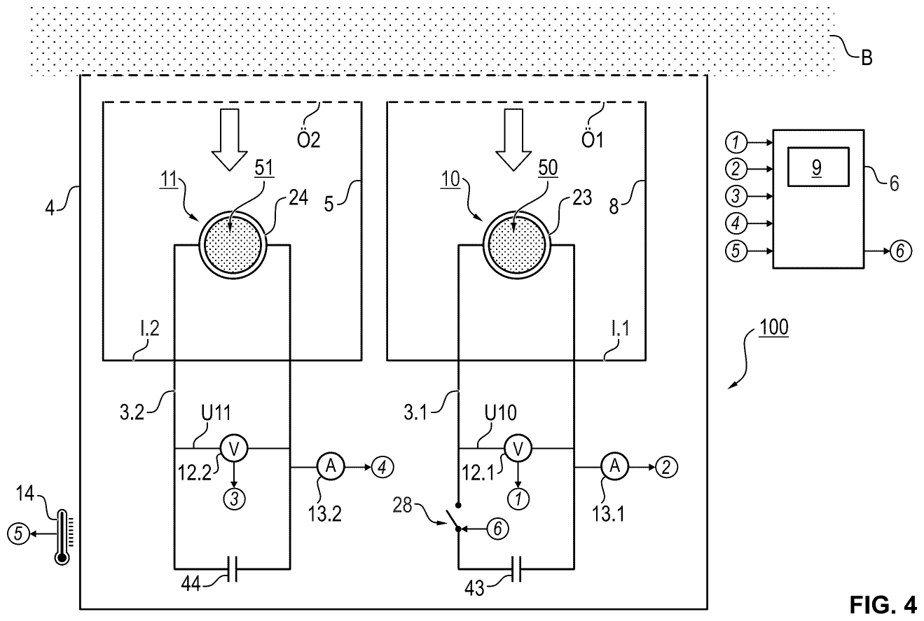

FIG. 4 shows a second embodiment of the gas measuring device 100. Coinciding reference signs have the same meanings as in FIG. 1. The detector chamber 8 is in fluid connection with the area B to be monitored via an opening Ö1, the compensator chamber 5 via an opening Ö2. The distance between the catalytic coating 23 and the rest of the detector 10 and the distance between a passivation coating 24 described below and the rest of the compensator 11 are shown exaggerated.

According to the second embodiment, the detector 10 and the compensator 11 are supplied with electrical energy independently of each other. A first electrical circuit 3.1 connects the detector 10 to a first voltage source 43, a second electrical circuit 3.2 connects the compensator 11 to a second voltage source 44. An optional controllable switch 28 opens or closes the electrical circuit 3.1 between the detector 10 and the voltage source 43, depending on its position (switch state).

A voltage sensor 12.1 measures the electrical voltage U10 applied to the detector 10. A current (amperage) sensor 13.1 measures the current I.1 flowing through the circuit for the detector 10. A voltage sensor 12.2 measures the electrical voltage U11 applied to the compensator 11. A current sensor 13.2 measures the current I.2 flowing through the circuit for the compensator 11. The current levels I.1 and I.2 are kept constant by a control unit.

In one implementation of the second embodiment, the voltage difference ΔU=U10−U11 is used as the detection variable. The voltage difference ΔU=U10−U11 is ideally equal to zero if no combustible target gas is present, but in practice it is also different from zero in the absence of combustible target gas. Therefore, a corrected voltage difference ΔUₖₒᵣᵣ=U10−U11−ΔU₀ is calculated and used as the or a detection variable. This detection variable correlates with the target gas concentration. The zero value ΔU₀ occurs when no combustible target gas is present and again compensates for design-related differences between the detector 10 and the compensator 11.

In the configuration shown in FIG. 4, the corrected voltage difference ΔUₖₒᵣᵣ=U10−U11−ΔU₀ acts as the overall detection variable.

The procedure just described for measuring the target gas concentration requires the following: Sufficient oxygen must be present in the detector chamber 8 so that the detector 10 is able to oxidize all combustible target gas. Only in this case the thermal energy released during oxidation can reliably be used as an indicator for the target gas concentration. If the target gas concentration is high, this requirement may no longer be met. In particular, it is possible that combustible target gas is present, but no oxygen for oxidation is present. If the target gas concentration would also in this situation only be measured using the thermal energy released during oxidation in this case, there is a risk that the target gas concentration measured will be too low, i.e. a dangerously high target gas concentration will not be detected. This can endanger a user and is therefore undesirable. The invention reduces the risk of this undesired event.

It is therefore preferable to apply a different procedure when the target gas concentration measured due to the released thermal energy has reached an upper concentration threshold. The upper concentration threshold is selected so that approximately all combustible target gas in the detector chamber 8 is oxidized when this upper concentration threshold is reached. In the other procedure, i.e. when the target gas concentration has reached the upper concentration threshold, the detection variable that correlates with the temperature of the detector segment 20 is not used to determine the target gas concentration. In the embodiment, the electrical voltage U10 applied to the detector 10 is therefore not used in the other procedure. The other approach takes advantage of the fact that hydrogen and many other combustible target gases have a higher thermal conductivity than air. Therefore, these combustible target gases cool down the heated compensator segment 38 of the compensator 11 more than ambient air.

In the other procedure, the temperature of the compensator segment 38 is measured-more precisely: an indicator for the temperature. The indicator for the temperature of the compensator segment 38 correlates with the target gas concentration to be measured. In the embodiment, the current I.3 (FIG. 1) or I.2 (FIG. 4) flowing through the compensator 11 is kept constant by a closed-loop control. The electrical voltage U11 applied to the compensator 11 correlates with the temperature of the compensator segment 38 and is therefore in the embodiment used as the compensator detection variable.

The gas measuring device 100 can be operated in at least two different modes. The control unit 6 effects the following: The gas measuring device 100 of the embodiment automatically switches from one mode to the other mode, depending on a predetermined oxidation criterion. In the embodiment, the gas measuring device 100 can be operated in the following modes:
in an oxidation measurement mode in which the gas measuring device 100 determines the target gas concentration as a function of the corrected bridge voltage ΔU_Bₖₒᵣᵣ (embodiment according to FIG. 1) or as a function of the corrected voltage difference ΔUₖₒᵣᵣ (embodiment according to FIG. 4), or
in a heat conduction measurement mode, in which the gas measuring device 100 determines the target gas concentration depending on the corrected compensator voltage U11ₖₒᵣᵣ=U11−U110.

In the embodiment, the corrected bridge voltage ΔU_Bₖₒᵣᵣ (embodiment according to FIG. 1) or the corrected voltage difference ΔUₖₒᵣᵣ (embodiment according to FIG. 4) act as the overall detection variable, and the corrected compensator voltage U11ₖₒᵣᵣ acts as the compensator detection variable.

When being operated in the oxidation measurement mode, the evaluation unit 9 applies a first evaluation rule on the measured overall detection variable wherein the first evaluation rule is given in a computer evaluable form. This first evaluation rule depends on the overall detection variable and optionally from the ambient temperature. As mentioned above, an optional temperature sensor 14 is configured to measure the ambient temperature, in one embodiment as a difference to a given reference temperature. When being operated in the heat conduction measurement mode, the evaluation unit 9 applies a second evaluation rule onto the measured compensator detection variable. The second evaluation rule depends on the compensator detection variable and optionally on the ambient temperature.

The two evaluation rules are determined in advance by applying a learning procedure on a sample. In one implementation both evaluation rules are given, and each evaluation rule comprises at least one parameter. Preferably at least one parameter is the reverse value of a proportional factor wherein this proportional factor describes the influence of the target gas concentration on the respectively used detection variable and wherein this proportional factor is empirically determined in advance. Optionally one parameter is the reverse value of a further proportional factor wherein the further proportional factor describes the influence of the ambient temperature on the respectively used detection variable.

The oxidation criterion is given such that it is fulfilled at least if there is sufficient oxygen in the detector chamber 8 to oxidize all combustible target gas. Preferably, the oxidation criterion depends on the measured target gas concentration. Different implementations of the oxidation criterion are possible.

Preferably, the gas measurement device 100 is initially operated in the oxidation measurement mode. The control unit 6 repeatedly checks, preferably at a fixed sampling rate, whether the oxidation criterion is still fulfilled. For example, the evaluation unit 9 compares the target gas concentration determined in the oxidation measurement mode with a predetermined first upper concentration threshold. Or the evaluation unit 9 checks how long the determined target gas concentration is above a predetermined lower concentration threshold.

As soon as the control unit 6 has detected that the oxidation criterion is no longer fulfilled, the control unit 6 causes the gas measuring device 100 to automatically switch to the heat conduction measurement mode. In one embodiment, the control unit 6 activates the switch 28 of FIG. 4 and ensures that no more electrical voltage is applied to the detector segment 20.

According to the invention, the evaluation unit 9 continuously determines an estimated value for the target gas concentration based on the overall detection variable when operated in the oxidation measurement mode and based on the compensator detection variable U11ₖₒᵣᵣ when operated in the heat conduction measurement mode. Preferably the gas measuring device 100 an estimated value for the target gas concentration based on the compensator detection variable also when being operated in the oxidation measurement mode.

In one implementation, a second upper concentration threshold is given which is greater than the first upper concentration threshold. The control unit 6 causes the gas measuring device 100 to switch to the heat conduction measurement mode when the evaluation unit 9 has detected the following event: The target gas concentration, which is determined as a function of the compensator detection variable, is above the second upper concentration threshold.

As already mentioned, the oxidation criterion is fulfilled if enough oxygen is present in the detector chamber 8 such that the detector 10 can oxidize every combustible target gas in the detector chamber 8. According to several implementations described above, the control unit 6 determines depending on the determined target gas concentration whether the oxidation criterion is fulfilled. It is also possible that an oxygen sensor 15 measures the content of oxygen in the gas sample being in the detector chamber. The control unit 6 checks depending on the measured oxygen content, i.e. depending on at least one value measured by the oxygen sensor 15, whether the oxidation criterion is fulfilled.

Preferably, the control unit 6 causes the gas measuring device 100 to switch back to the oxidation measurement mode when a predefined switch-back criterion is met.

In a preferred form of implementation, the switch-back criterion is fulfilled if the evaluation unit 9 has detected the following event: The target gas concentration, which has been measured in the heat conduction measurement mode, i.e. depending on the compensator detection variable U11ₖₒᵣᵣ, is below a predetermined upper concentration threshold. This upper concentration threshold is preferably smaller than the first upper concentration threshold mentioned above.

It is also conceivable that the control unit 6 has detected the following event, for example based on a recorded user input: The detector chamber 8 has been flushed out with a gas sample that contains sufficient oxygen. For example, the user has carried the gas detection device 100 into an area that has sufficient oxygen and is free of combustible target gas.

The following configuration is also conceivable: The optional oxygen sensor 15 has measured a sufficiently high oxygen concentration in the detector chamber 8.

In the embodiments described above the gas measuring device 100 automatically switch from the one mode into the other mode. It is also possible that the gas measuring device comprises a selection switch wherein a user can activate this selection switch. By operating the selection switch the user specifies whether the gas measuring device 100 is to be operated in the oxidation measurement mode or in the heat conduction mode.

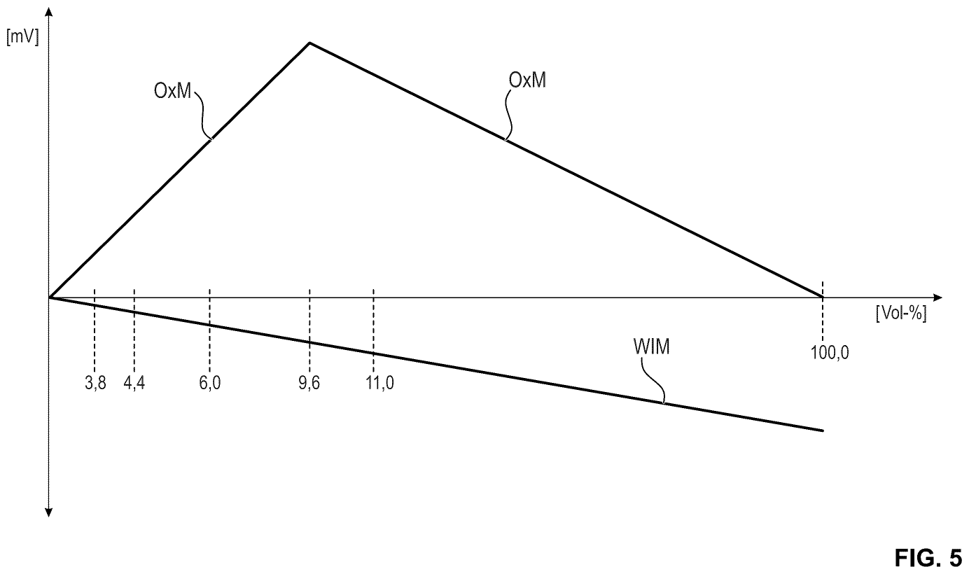

FIG. 5 shows schematically how the respective detection parameter depends on the target gas concentration. The concentration of the combustible target gas methane (CH₄) is plotted on the x-axis and the value for the respective detection parameter is plotted on the y-axis. The O×M curve refers to the oxidation measurement mode in which the target gas concentration is determined as a function of the overall detection variable, i.e. in this case as a function of the corrected bridge voltage ΔU_Bₖₒᵣᵣ=ΔU_B−ΔU_B₀ (embodiment according to FIG. 1) or the corrected voltage difference ΔUₖₒᵣᵣ=U10−U11−ΔU₀ (embodiment according to FIG. 4). The curve WIM refers to the heat conduction measurement mode in which the target gas concentration is determined as a function of the compensator detection variable, i.e. in this case as a function of the corrected compensator voltage U11ₖₒᵣᵣ=U11−U11₀.

In the example in FIG. 5, methane is the combustible target gas. The lower explosion limit (LEL) in this example is 4.4% by volume. If the gas measuring device 100 has measured a target gas concentration that is greater than α*LEL, it issues an alarm or causes a spatially remote receiver to issue an alarm. This applies regardless of the mode in which the target gas concentration was measured. The factor α is between 0 and 0.6 and is preferably less than 0.5. In one implementation, the gas measuring device 100 issues a pre-alarm if the target gas concentration is greater than α₁*LEL, and a main alarm if the target gas concentration is greater than α*LEL. Here, 0<α₁<α<=0.6 is valid. For example, α₁=0.2 and α=0.4.

As already explained, during use of the gas measuring device, the detector chamber 8 is permanently in a fluid connection (fluid communication) with the spatial area to be monitored, and a gas sample continuously flows into the detector chamber 8. The overall detection variable assumes the maximum value at a target gas concentration of 9.6 vol % of methane in air, which is the so-called stoichiometric concentration at which all oxygen in the detection chamber 8 is consumed. At a higher target gas concentration, the following two effects occur:
Because there is not enough oxygen in the detection chamber 8, the heated detector segment 20 oxidizes less combustible target gas and the temperature of the detector segment 20 decreases again.
In addition, the gas sample in the detector chamber 8 has a higher thermal conductivity because methane has a higher thermal conductivity than air.

For these two reasons, the overall detection variable (the corrected bridge voltage ΔU_Bₖₒᵣᵣ, FIG. 1, or the corrected voltage difference ΔUₖₒᵣᵣ, FIG. 4) decreases again.

As already mentioned above, in a preferred embodiment, the control unit 6 causes the gas measuring device 100 to automatically switch to the heat conduction measurement mode if the target gas concentration determined in the oxidation measurement mode reaches or exceeds a predetermined first upper concentration threshold. This first upper concentration threshold is below the stoichiometric concentration and is 6% by volume in the example shown.

In addition, an embodiment was mentioned above in which the control unit 6 causes the gas measuring device 100 operated in the heat conduction measurement mode to switch back to the oxidation measurement mode when a predetermined switch-back criterion is met. This switch-back criterion is fulfilled if the target gas concentration determined in the heat conduction measurement mode is less than a predetermined switch-back threshold. In the example shown, this switch-back threshold is 3.8% in volume.

If the target gas concentration changes quickly during operation in the oxidation measurement mode, the above-mentioned threshold of 6% in volume may in some cases not be sufficient. For safety reasons, a second upper concentration threshold of 11% in volume, for example, is given. The control unit 6 causes the gas measuring device 100 to switch from the oxidation measurement mode to the heat conduction measurement mode when the following event is detected: depending on the compensator detection variable U11ₖₒᵣᵣ the evaluation unit 9 determines a target gas concentration above the second upper concentration threshold. The control unit 6 causes the switchover regardless of which target gas concentration is determined in the oxidation measurement mode, i.e. depending on the overall detection variable.

The compensator segment 38 must be heated to approximately the same temperature as the detector segment 20 so that the detector 10 and the compensator 11 react sufficiently similarly to ambient conditions, including ambient conditions that are not measured directly. In particular the detector 10 and the compensator 11 should react sufficiently similarly to ambient pressure and ambient humidity and to the chemical composition of the ambient air. In the embodiment, the compensator 11 should nevertheless not oxidize any combustible target gas, neither if the measured value for the target gas concentration is derived as a function of the detector voltage U10 and of the compensator voltage U11, nor if this measured value is derived only as a function of the compensator voltage U11. In particular, the compensator 11 must not oxidize any combustible target gas to a relevant extent if the target gas concentration is calculated as a function of the increased thermal conductivity and thus as a function of the compensator voltage U11. If the compensator 11 oxidizes even a relatively small amount of combustible target gas, this effect masks and therefore hides the effect of the increased thermal conductivity, so that there is a high risk that an incorrect measured result will be provided.

In the embodiment, the wire for the compensator segment 38 of the compensator 11 is provided. This wire is coated with a ceramic that is free of catalytically active material. In one embodiment, aluminum oxide is used for this purpose.

The inventors have determined in internal experiments the following result: If this ceramic coating of the compensator segment 38 comes into contact with a gas sample and this gas sample contains hydrogen, the heated compensator segment 38 oxidizes some of the hydrogen, and the thermal energy thereby released outweighs the influence of the greater thermal conductivity. Therefore, the inventors have investigated in internal experiments different chemical compositions to determine how well these chemical compounds prevent the undesirable effect that the compensator 11 oxidizes hydrogen. In the experiments, for each chemical compound studied, a liquid comprising the chemical compound and water as a solvent was applied to the surface of the compensator functional component 51 of the compensator 11 after this wire was coated with the ceramic. The liquid was applied by immersing the coated wire in an immersion bath containing this liquid, then removing it from the immersion bath and drying it so that the solvent evaporates. This creates a coating on the compensator functional component 51.

This coating comes into contact with the gas sample. It is referred to below as the “passivation coating” 24. As a rule, it is inevitable that some of the liquid will dissolve the ceramic coating, so that a transition area occurs between the ceramic coating and the passivation coating 24. The passivation coating 24 surrounds the compensator functional component 51 and physically and chemically separates the compensator functional component 51 from an environment and thus from the gas sample. On the other hand, the gas sample is in thermal contact with the compensator functional component 51 despite the passivation coating 24, so that the changed thermal conductivity of the gas sample has an effect on the temperature of the compensator segment 38.

The procedure just described can also be used to manufacture a compensator 11 for productive use. The gas measuring device can also be used for other combustible target gases than hydrogen.

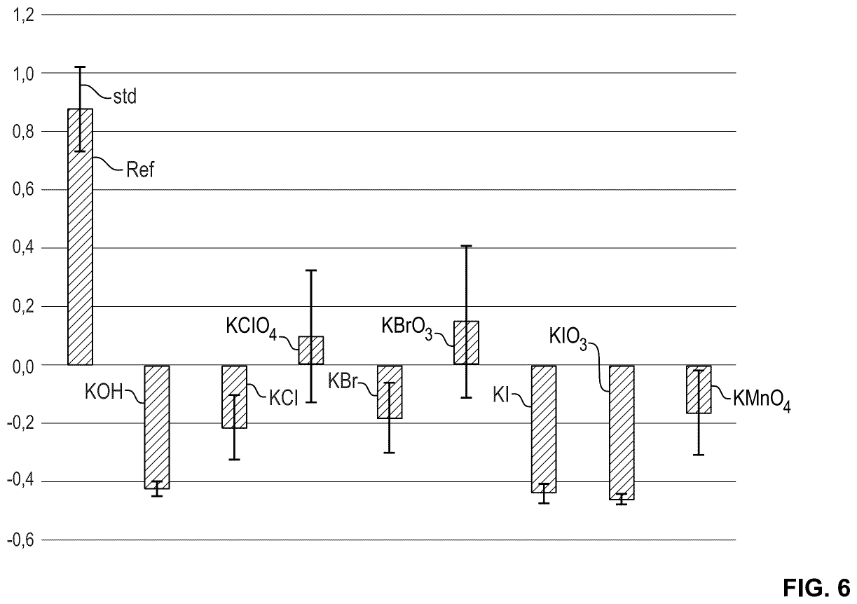

FIG. 6 shows the result of several measurements for eight different possible passivation coatings 24 on the compensator functional component 51 and, for comparison, measurements for a compensator functional component 51 without passivation coating. The relative change in the detection variable U11 (electrical voltage applied to the compensator 11) is plotted on the y-axis. The relative change is a quotient. The numerator is the difference between the detection variable U11 at a hydrogen concentration of 2 vol %=50% lower explosion limit (LEL) and the detection variable U11 in the absence of hydrogen, in mV in each case. The denominator is the hydrogen concentration, measured in % LEL.

In order to apply the respective passivation coating 24, the wire of the compensator segment 38 was first provided with the ceramic coating described above. There by the compensator functional component 51 is manufactured. The compensator functional component 51 I think the ceramic-coated wire 38 was then immersed in an immersion bath containing the chemical compound to be investigated and water as the solvent. The compensator functional component 51 was then removed from the immersion bath and heated by applying an electrical voltage.

Several tests were carried out for each passivation coating 24. The respective hatched vertical bar describes the average value that the detection variable U11 assumes for this passivation coating 24. The respective empirical standard deviation std is also entered.

The following passivation coatings 24 were examined:
3% by weight potassium hydroxide (KOH),
10% by weight potassium chloride (KCl),
1.5% by weight potassium perchlorate (KClO₄),
15% by weight potassium bromide (KBr),
5% by weight potassium bromate (KBrO₃),
5% by weight potassium permanganate (KMnO₄),
20% by weight potassium iodide (KI),
7.5% by weight potassium iodate (KIO₃).
   In FIG. 6, Ref refers to a reference compensator without passivation coating.

The weight percentages were determined depending on the solubility and manageability of the respective chemical compound. They apply to the aqueous solution of the immersion bath, not to the dried passivation coating 24.

The three compounds KOH, KI and KIO₃ for the passivation coating 24 lead to a considerable relative change to the negative, which is desirable. With these three passivation coatings 24, the effect of the increased thermal conductivity clearly exceeds the effect resulting from the fact that some target gas (hydrogen) is still oxidized despite the passivation coating 24.

The compensator 11 should not only be catalytically inactive immediately after manufacture, but also over a longer time period during use. For this reason, the inventors additionally compared in a long-term test the three chemical compounds that were identified as suitable in the test according to FIG. 6. In this long-term test, only the heated compensator functional component 51 was examined, not the detector 10. This long-term test extended over 84 days. Constant ambient conditions of, for example, 25 degrees C. and 40% relative humidity were created in an enclosed test chamber in the form of a temperature cabinet. The compensator segment 38 was raised to a temperature at which the detector segment 20 would oxidize target gas. This temperature is between 450 degrees C. and 550 degrees C. Once a day, the heated compensator functional component 51 was exposed to a hydrogen concentration of 2 vol %=50% LEL for a sufficiently long time.

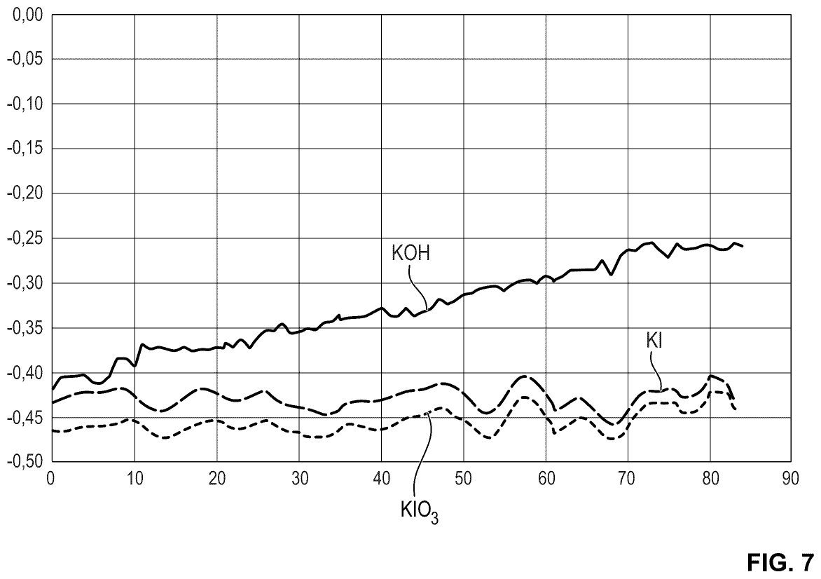

FIG. 7 shows test results for three different passivation coatings 24. The time in days is plotted on the x-axis and the relative change in the detection variable U11 on the y-axis. The relative change is defined as described with reference to FIG. 6.

The measurement curve KOH refers to 3 wt. % potassium hydroxide (KOH) in water as a solvent, the measurement curve KI to 20 wt. % potassium iodide (KI) in water, the measurement curve KIO₃ to 7.5 wt. % potassium iodate (KIO₃) in water. The two coatings that led to the measurement curves KI and KIO₃ are well suited because the compensator 11 also remained catalytically inactive in this long-term test. On the other hand, the coating that led to the measurement curve KOH is much less suitable because the compensator 11 became catalytically active over time.

A process of manufacturing the compensator 11 of the gas measuring device 100 according to the invention comprises the following steps:
The electrically conductive segment 38 of the compensator 11 is provided.
The ceramic coating 21 is applied to the compensator segment 38. This creates the compensator functional component 51.
The passivation coating 24 is applied to the ceramic coating 21.

Preferably, the step of applying the ceramic coating 21 comprises the following steps:
The compensator segment 38 is lowered into an immersion bath. The immersion bath contains a solution of the chemical compound in water or in another suitable solvent.
The compensator segment 38 is then removed from the immersion bath.
An electrical voltage is applied to the compensator segment 38, which voltage heats the compensator segment 38. This step forms the ceramic coating 21.
The compensator functional component 51 is now created.

Accordingly, the step of applying the passivation coating 24 to the ceramic coating 21 and thus to the compensator functional component 51 comprises the following steps:
The compensator functional component 51 is lowered into an immersion bath. The immersion bath contains a solution of a chemical compound comprising iodine, preferably an iodide or an iodate.
The compensator functional component 51 is then removed from the immersion bath again.
An electrical voltage is applied to the compensator functional component 51, and the effected current heats the compensator functional component 51. This forms the passivation coating 24.

In one embodiment, the chemical compound comprises an iodide. It is possible that heating the compensator segment 38 during manufacture or even during use may cause the passivation coating 24 to be oxidized, thereby converting the iodide to an iodate or converting at least a portion of the iodide to iodate. Even then, the passivation coating 24 can generally achieve the desired effect of not oxidizing combustible target gas to any appreciable extent.

While specific embodiments of the invention have been shown and described in detail to illustrate the application of the principles of the invention, it will be understood that the invention may be embodied otherwise without departing from such principles.

### LIST OF REFERENCE CHARACTERS

| | |
|---|---|
| 1 | Inner housing, surrounds the detector chamber 8 and the |
| | compensator chamber 5 |
| 2 | Flame guard (flame protection) in the inner housing 1 |
| 3.1 | Electrical circuit, connects the detector 10 with the voltage |
| | source 43 |
| 3.2 | Electrical circuit, connects the compensator 11 with the |
| | voltage source 44 |
| 4 | Outer housing, surrounds the inner housing 1, the elements |
| | R10, R11, R20, R21, the current and voltage sensors and |
| | the voltage source (power supply unit) 42 |
| 5 | Compensator chamber, surrounds the compensator 11, has |
| | the opening Ö2 |
| 8 | Detector chamber, surrounds the detector 10, has the |
| | opening Ö1 |
| 9 | Signal-processing evaluation unit, determines the target gas |
| | concentration, in one embodiment a component of the |
| | control unit 6 |
| 10 | Detector, comprises the detector segment 20, the ceramic |
| | coating 21 and the catalytic coating 23 |
| 11 | Compensator, comprises the compensator functional |
| | component 51 with the compensator segment 38 and the |
| | ceramic coating 21 as well as the passivation coating 24 |
| 12.1 | Voltage sensor, measures the electrical voltage U10 |
| | applied to the detector 10 |
| 12.2 | Voltage sensor, measures the electrical voltage U11 |
| | applied to the compensator 11 |
| 13.1 | Current sensor, measures the current I.1 of the electric |
| | current flowing through the detector 10 |
| 13.2 | Current sensor, measures the current I.2 of the electric |
| | current flowing through the compensator 11 |
| 14 | Temperature sensor, measures the difference between the |
| | ambient temperature and a given reference temperature |
| 15 | Oxygen sensor, measures the oxygen content in the |
| | detector chamber 8 |
| 20 | Electrically conductive detector segment |
| 21 | Ceramic coating around the detector segment 20 and |
| | around the compensator segment 38 |
| 22 | Mounting plate |
| 23 | Catalytically effective coating on the ceramic coating 21 |
| | of the detector 10 |
| 24 | Passivation coating on the ceramic coating of the |
| | compensator 11 |
| 28 | Switch that selectively allows or prevents electrical |
| | current from flowing through the detector segment 20, |
| | sets the mode in which the gas detection device 100 |
| | is operated |
| 30 | Electrically conductive track (trace), that the detector |
| | segment 20 comprises |
| 31 | Support plate (carrier board) for the conductor track 30 |
| 33 | Wafer substrate |
| 34 | Electrical contact points for the conductor track 30 |
| 35 | Protective layer on the conductor track 30 |
| 36 | Mechanical supports for the detector segment 20 |
| 38 | Electrically conductive compensator segment |
| 40 | Voltage sensor, measures the bridge voltage ΔU_B |
| 41 | Current sensor, measures the current I.3 in the |
| | Wheatstone measuring bridge |
| 42, 43, | Voltage source, power supply unit |
| 44 | |
| 50 | Functional component of the detector 10, comprises the |
| | heated detector segment 20 and the ceramic coating 21, |
| | surrounded by the catalytically active coating 23 |
| 51 | Functional component of the compensator 11, comprises |
| | the heated compensator segment 38 and the ceramic |
| | coating 21, surrounded by the passivation coating 24 |
| 100 | Gas measuring device, comprises the detector 10, the |
| | compensator 11, the temperature sensor 14, the |
| | control unit 6, the outer housing 4, the inner housing 1, |
| | the power supply unit 42 and the flame guard 2 |
| α₁ | If the target gas concentration is greater than α*LEL, the |
| | gas detection device 100 emits a main alarm |
| α₂ | If the target gas concentration is greater than α₁*LEL, the |
| | gas detection device 100 issues a pre-alarm |
| B | Spatial area to be monitored for combustible target gas |
| I.1 | Current (amperage) flowing through the detector segment |
| | 20, measured by the current sensor 13.1 |
| I.2 | Current (amperage) flowing through the compensator |
| | segment 38, measured by the current sensor 13.2 |
| I.3 | Current strength in the Wheatstone measuring bridge, |
| | measured by current strength sensor 41 |
| KBr | Potassium bromide |
| KBrO₃ | Potassium bromate |
| KCl | Potassium chloride |
| KClO₄ | Potassium perchlorate |
| AI | Potassium iodide |
| KIO₃ | Potassium iodate |
| KMnO₄ | Potassium permanganate |
| KOH | Potassium hydroxide |
| OxM | Detection variable as a function of the target gas |
| | concentration when operating in the oxidation |
| | measurement mode |
| Ö1 | Opening in the detector chamber 8 |
| Ö2 | Opening in the compensator chamber 5 |
| Ö | Opening in the outer housing 4 |
| Ref | Reference compensator without passivation coating |
| R10, | Electrical resistance element, connected in parallel to the |
| R20 | detector 10 |
| R11, | Electrical resistance element, connected in parallel to the |
| R21 | compensator 11 |
| U10 | Electrical voltage applied to the detector 10, is measured |
| | by the voltage sensor 12.1 in one embodiment |
| U11 | Electrical voltage, which is applied to the compensator 11, |
| | is measured by the voltage sensor 12.2 in one embodiment, |
| | functions as the compensator detection variable |
| U11₀ | Zero value of the compensator voltage U11 |
| U11ₖₒᵣᵣ | Corrected compensator voltage, is equal to U11-U11₀ |
| ΔU | Voltage difference, is equal to U10-U11 |
| ΔU₀ | Zero value (zero point) of the voltage difference ΔU |
| ΔU_B | Bridge voltage of the Wheatstone bridge, measured by the |
| | voltage sensor 40, is equal to (U10-U11)/2 |
| ΔUₖₒᵣᵣ | Corrected voltage difference, is equal to U10-U11-ΔU₀, |
| | acts as the overall detection variable |
| ΔU_B₀ | Zero value (zero point) of the bridge voltage ΔU_B |
| ΔU_Bₖₒᵣᵣ | Corrected bridge voltage, is equal to ΔU_B-ΔU_B₀, acts |
| | as the overall detection variable |
| WlM | Detection variable as a function of the target gas |
| | concentration when operating in the heat conduction |
| | measurement mode |

What is claimed is:

1. A gas measuring device for measuring a concentration of a combustible target gas in a spatial area, the gas measuring device comprising:
a detector comprising an electrically conductive detector segment;
a compensator comprising a compensator functional component and a passivation coating, the compensator functional component comprising an electrically conductive compensator segment;
an overall detection variable sensor; and
a compensator detection variable sensor,
wherein the gas measuring device is configured such that a gas sample can at least temporarily flow from a spatial area to be monitored into an interior of the gas measuring device,
wherein the gas measuring device is configured to apply an electrical voltage to the detector segment such that the detector segment is heated and to apply an electrical voltage to the compensator segment such that the compensator segment is heated,
wherein the heating of the detector segment causes a combustible target gas in a gas sample inside the gas measuring device to oxidize, and the oxidation causes an increase in a temperature of the detector segment,
wherein the passivation coating surrounds the compensator functional component and is located between a gas sample inside the gas measuring device and the compensator functional component,
wherein the passivation coating physically and chemically separates the gas sample from the compensator functional component,
wherein the passivation coating consists of at least 50% by weight of a chemical compound comprising iodine,
wherein the overall detection variable sensor is configured to measure an overall detection variable which depends on the temperature of the detector segment and on the temperature of the compensator segment,
wherein the compensator detection variable sensor is configured to measure a compensator detection variable which depends on the temperature of the compensator segment,
wherein the gas measuring device is configured to be operated in an oxidation measurement mode and in a heat conduction measurement mode, and
wherein the gas measuring device is configured to determine the concentration of the combustible target gas in the gas sample in the interior of the gas measuring device based on the measured overall detection value when operated in the oxidation measurement mode, and based on the measured compensator detection variable when operated in the heat conduction measurement mode.

2. A gas measuring device according to claim 1, wherein the chemical compound comprising iodine of the passivation coating consists of at least 50% by weight of an iodide or an iodate of an alkali metal or an alkaline earth metal.

3. A gas measuring device according to claim 2, wherein the alkali metal is potassium.

4. A gas measuring device according to claim 3, wherein the chemical compound is potassium iodide or potassium iodate.

5. A gas measuring device according to claim 1, wherein the passivation coating consists of at least 80% by weight of the chemical compound comprising iodine.

6. A gas measuring device according to claim 1, wherein the chemical compound comprising iodine of the passivation coating consists of at least 80% by weight of an iodide or an iodate of an alkali metal or an alkaline earth metal.

7. A gas measuring device according to claim 6, wherein the alkali metal is potassium.

8. A gas measuring device according to claim 7, wherein the chemical compound is potassium iodide or potassium iodate.

9. A gas measuring device according to claim 1, wherein the passivation coating consists of at least 95% by weight of the chemical compound comprising iodine.

10. A gas measuring device according to claim 1, wherein the gas measuring device is configured:
to check whether a given oxidation criterion is fulfilled, wherein the oxidation criterion is at least fulfilled if there is still sufficient oxygen in the interior of the gas detection device for oxidation of the combustible target gas by the detector segment,
to be operated in the oxidation measurement mode as long as the oxidation criterion is met, and
to switch automatically to the heat conduction measurement mode if the oxidation criterion is no longer met.

11. A gas measuring device according to claim 10, wherein the gas measuring device is configured such that the oxidation criterion is at least then fulfilled if the target gas concentration, which is determined as a function of the measured overall detection variable, is below a given first upper concentration threshold.

12. A gas measuring device according to claim 11, wherein the gas measuring device is configured such that the oxidation criterion is additionally fulfilled at least if the target gas concentration, which is determined as a function of the measured compensator detection variable, is below a given second upper concentration threshold, wherein the second upper concentration threshold is greater than the first upper concentration threshold.

13. A gas measuring device according to claim 10, wherein a detector chamber surrounds the detector, and wherein an oxygen sensor is configured for measuring the content of oxygen in a gas sample in the detector chamber;
wherein the gas measuring device is configured to check whether the given oxidation criterion is fulfilled depending on the measured oxygen content.

14. A gas measuring process comprising:
providing a gas measuring device for measuring a concentration of a combustible target gas in a spatial area, the gas measuring device comprising: a detector comprising an electrically conductive detector segment; a compensator comprising a compensator functional component and a passivation coating, the compensator functional component comprising an electrically conductive compensator segment; an overall detection variable sensor; and a compensator detection variable sensor,
wherein the gas measuring device is configured such that a gas sample can at least temporarily flow from a spatial area to be monitored into the interior of the gas measuring device,
wherein the gas measuring device is configured to apply an electrical voltage to the detector segment such that the detector segment is heated and to apply an electrical voltage to the compensator segment such that the compensator segment is heated,
wherein the heating of the detector segment causes a combustible target gas to oxidize in a gas sample in the interior of the gas measuring device, and the oxidation causes an increase in a temperature of the detector segment,
wherein the passivation coating surrounds the compensator functional component and is located between a gas sample in the interior of the gas measuring device and the compensator functional component and the passivation coating physically and chemically separates the gas sample from the compensator functional component,
wherein the passivation coating consists of at least 50% by weight of a chemical compound comprising iodine,
wherein the overall detection variable sensor is configured to measure an overall detection variable which depends on the temperature of the detector segment and on the temperature of the compensator segment,
wherein the compensator detection variable sensor is configured to measure a compensator detection variable which depends on the temperature of the compensator segment, wherein the gas measuring device is configured to be operated in an oxidation measurement mode and in a heat conduction measurement mode,
wherein the gas measuring device is configured to determine the concentration of the combustible target gas in the gas sample in the interior of the gas measuring device depending on the measured overall detection value when operating in the oxidation measurement mode and depending on the measured compensator detection variable when operating in the heat conduction measurement mode; and
measuring a concentration of hydrogen, as the combustible target gas, with the gas measuring device.

15. A gas measurement process for measuring a concentration of a combustible target gas using a gas measuring device which comprises a detector with a detector segment, a compensator with a compensator functional component and a passivation coating, an overall detection variable sensor and a compensator detection variable sensor,
wherein the compensator functional component comprises an electrically conductive compensator segment,
wherein the passivation coating surrounds the compensator functional component and is located between a gas sample in an interior of the gas measuring device and the compensator functional component,
wherein the passivation coating consists of at least 50% by weight of a chemical compound comprising iodine,
wherein the gas sample flows at least temporarily from a spatial area to be monitored into the interior of the gas measuring device,
wherein the passivation coating comes into contact with the gas sample in the interior of the gas measuring device and physically and chemically separates the gas sample from the compensator functional component;
wherein the process comprises the steps of:
applying an electrical voltage to the compensator segment such that the compensator segment is heated,
wherein with the gas measuring device operating in an oxidation measurement mode, the process further comprises:
applying an electrical voltage to the detector segment such that the detector segment is heated, and the heating of the detector segment causes a combustible target gas in the gas sample in the interior of the gas measuring device to be oxidized and the oxidation increases the temperature of the detector segment;
measuring, with the overall detection variable sensor, an overall detection variable which depends on the temperature of the detector segment and on the temperature of the compensator segment; and
determining the concentration of a combustible target gas in the gas sample in the interior of the gas measuring device as a function of the measured overall detection variable, and
wherein with the gas measuring device operating in a heat conduction measurement mode,
the process further comprises:
measuring, with the compensator detection variable sensor, a compensator detection variable that depends on the temperature of the compensator segment; and
determining the concentration of a combustible target gas in the gas sample in the interior of the gas measuring device as a function of the measured compensator detection variable.

16. A gas measurement process according to claim 15, wherein with the gas measuring device operating in the heat conduction measurement mode, no electrical voltage is applied to the detector segment.

17. A gas measurement process according to claim 15, further comprising the steps of:
initially operating the gas measuring device in the oxidation measurement mode;
during the operation of the gas measuring device in the oxidation measurement mode, checking whether a given oxidation criterion is met;
remaining the gas measuring device in the oxidation measurement mode when the oxidation criterion is met; and
automatically switching to operating the gas measuring device in the heat conduction measurement mode if the oxidation criterion is not met,
wherein the oxidation criterion is at least fulfilled if there is still sufficient oxygen in the interior of the gas detection device to oxidize a combustible target gas by the detector segment.
